(19) United States
(12) Patent Application Publication
(10) Pub. No.: US 2018/0355172 A1
(43) Pub. Date: Dec. 13, 2018

(54) POLYAMIDE ACID, POLYIMIDE, POLYAMIDE ACID SOLUTION, POLYIMIDE LAMINATE, FLEXIBLE DEVICE SUBSTRATE, AND PRODUCTION METHODS THEREOF

(71) Applicant: KANEKA CORPORATION, Osaka-shi, Osaka (JP)

(72) Inventor: Mari UNO, Otsu-shi (JP)

(73) Assignee: Kaneka Corporation, Osaka-shi, Osaka (JP)

(21) Appl. No.: 15/778,800

(22) PCT Filed: Nov. 25, 2016
(86) PCT No.: PCT/JP2016/085012

§ 371 Date: May 24, 2018

(30) Foreign Application Priority Data
Dec. 9, 2015 (JP) 2015-240586

(51) Int. Cl. C08L 79/08; C08K 3/36; B32B 7/02; B32B 27/28; C08G 73/10

(52) U.S. Cl. CPC C08L 79/08; C08K 3/36; B32B 7/02; B32B 27/281; B82Y 30/00; C08G 73/1078; B32B 2457/08; B32B 2457/12; B32B 2457/20; C08G 73/1007

(57) ABSTRACT

Provided are a nanosilica-containing polyamide acid and a nanosilica-containing polyimide. The nanosilica-containing polyamide acid contains a polyamide acid, which is a polymer of an alicyclic tetracarboxylic acid dianhydride and an aromatic diamine containing a carboxyl group, and nanosilica, and is excellent in heat resistance, low thermal expansion and transparency, and exhibits low double refraction. Also provided is a product or a member that meets requirements of high heat resistance and high transparency by using the nanosilica-containing polyamide acid and the nanosilica-containing polyimide.

### TECHNICAL FIELD

The present invention relates to a polyamide acid, a polyimide, a polyamide acid solution, a polyimide laminate, a flexible device substrate, and production methods thereof. The present invention relates to an electronic device material using the polyimide, a TFT substrate, a transparent electrode substrate, a flexible display substrate, a color filter, a printed matter, an optical material, a liquid crystal display device, an image display device such as an organic EL and electronic paper, a 3-D display, a solar cell, a touch panel, a transparent conductive film substrate, and substitute material for a portion where glass is currently used.

### TECHNICAL BACKGROUND

In recent years, along with rapid progresses of liquid crystals, displays such as organic EL and electronic paper, solar cells, and electronics such as touch panels, there are increasing demands for reduction in thickness and weight and increase in flexibility of devices. Therefore, a thin, lightweight and flexible plastic film substrate as an alternative to a glass substrate has been studied.

In such devices, various electronic elements such as thin film transistors and transparent electrodes are formed on a substrate. However, a high temperature process is required for the formation of these electronic elements. Therefore, sufficient heat resistance is required for a plastic film substrate to be applicable to a high temperature process. Further, when these electronic elements (inorganic elements) formed of an inorganic material are formed on a film, due to a difference in linear thermal expansion coefficient between the inorganic material and the film, the film may warp after the formation of the inorganic elements, and further, the inorganic elements may be destroyed. Therefore, a substrate material having a thermal expansion coefficient equivalent to that of an inorganic material while being heat resistant has been desired.

Further, when light originated from a display element (a liquid crystal, an organic EL, or the like) is emitted through a plastic film substrate (for example, a bottom emission type organic EL or the like), a substrate material is required to be transparent. In particular, a high light transmittance in a wavelength region of 400 nm or less, which is a visible light region, is required. Further, when light passes through a phase difference film or a polarizing plate (for example, a liquid crystal display, a touch panel, or the like), in addition to transparency, a substrate material is required to have high optical isotropy.

These device manufacturing processes are divided into batch type processes and roll-to-roll type processes. When a roll-to-roll manufacturing process id used, new equipment is required, and several problems due to rotation and contact must be overcome. On the other hand, a batch type process is a process in which a coating resin solution is coated on a glass substrate and is dried, and after substrate formation, peeling is performed. Therefore, a batch type process can use existing processing equipment for a glass substrate such as a TFT substrate and thus is advantageous from a point of view of cost. From such a background, heat resistance, development of a substrate material that is applicable to existing batch processes and has excellent heat resistance, low thermal expansion and transparency is strongly desired.

As a substrate material that meets the above requirements, a polyimide-based material known as a substrate material excellent in heat resistance has been studied. It is known that, in order to obtain a polyimide that has a high transparency and further exhibits low thermal expansion, it is effective to use a monomer having a rigid structure or to use an alicyclic monomer (Patent Document 1). Further, it is known that compounding nanoparticles of silica or the like and a polyimide is effective for achieving low thermal expansion (Patent Documents 2 and 3).

### RELATED ART

### Patent Documents

### [Patent Document 1] Japanese Patent Laid-Open Publication No. 2013-166929.

[Patent Document 2] International Publication No. WO 2014/051050.
[Patent Document 3] International Publication No. WO 2013/179727.

### SUMMARY OF THE INVENTION

### Problems to be Solved by the Invention

The present invention is accomplished in view of the above situation and is intended to obtain a nanosilica-containing polyamide acid that is excellent in heat resistance, low thermal expansion and transparency, and further exhibits low double refraction and is also excellent in mechanical strength, and to obtain a nanosilica-containing polyimide that is obtained from the nanosilica-containing polyamide acid. Further, the present invention is intended to provide a product or a member that meets requirements of high heat resistance and high transparency by using the nanosilica-containing polyamide acid and the nanosilica-containing polyimide.

### Means for Solving the Problems

It is found that the above problem can be solved by using a nanosilica-containing polyamide acid that contains a polyamide acid, which is obtained by causing an alicyclic tetracarboxylic acid dianhydride and an aromatic diamine containing a carboxyl group to react with each other, and nanosilica, and by using a nanosilica-containing polyimide obtained from this nanosilica-containing polyamide acid.

The present invention has the following aspects.

A nanosilica-containing polyamide acid includes: a polyamide acid that is a polymer of an alicyclic tetracarboxylic acid dianhydride and an aromatic diamine containing a carboxyl group; and nanosilica.

A nanosilica-containing polyimide includes: a polyimide that is an imidized product of an alicyclic tetracarboxylic acid dianhydride and an aromatic diamine containing a carboxyl group; and nanosilica.

### Effect of the Invention

The nanosilica-containing polyamide acid and the nanosilica-containing polyimide according to an embodiment of the present invention have low double refraction in addition to being excellent in heat resistance, low thermal expansion and transparency, and thus can be suitably used as a film and a coating film for all commonly known members that are required to be heat resistant. Further, the nanosilica-containing polyamide acid according to an embodiment of the present invention is soluble in various organic solvents, and thus, can be easily applied onto various substrates.

### MODE FOR CARRYING OUT THE INVENTION

In Patent Document 1, a polyimide is illustrated that is obtained using an alicyclic tetracarboxylic acid dianhydride excellent in heat resistance and low thermal expansion. However, there is no description about double refraction, and transparency is insufficient for being applicable to the above-described applications. In Patent Document 2, a resin composition containing a polyimide synthesized from a phenolic hydroxyl group-containing diamine and silica fine particles is described, and a resin composition having high transparency and low thermal expansion is illustrated. However, there is no description about double refraction. In Patent Document 3, a material is illustrated that is obtained by adding silica particles to a polyimide obtained using a tetracarboxylic acid dianhydride having a special structure. However, there is no description about double refraction. Further, the material described in Patent Document 3 has very low mechanical strength and thus is difficult to be used as a substrate material.

In the following, the present invention is described in detail.

The nanosilica-containing polyamide acid in an embodiment of the present invention is obtained by compounding a polyamide acid obtained by causing an alicyclic tetracarboxylic acid dianhydride and an aromatic diamine containing a carboxyl group to react with each other (that is, a polymer of an alicyclic tetracarboxylic acid dianhydride and an aromatic diamine containing a carboxyl group) and nanosilica.

First, the alicyclic tetracarboxylic acid dianhydride is described. The alicyclic tetracarboxylic acid dianhydride in this specification refers to a tetracarboxylic acid dianhydride having a cycloalkane structure. Examples of the alicyclic tetracarboxylic acid dianhydride include (1S, 2R, 4S, 5R)-cyclohexane tetracarboxylic acid dianhydride (cis, cis, cis-1,2,4,5-cyclohexane tetracarboxylic acid dianhydride), (1S, 2S, 4R, 5R)-cyclohexane tetracarboxylic acid dianhydride, (1R, 2S, 4S, 5R)-cyclohexane tetracarboxylic acid dianhydride, bicyclo [2.2.2] octane-2,3,5,6-tetracarboxylic acid dianhydride, bicyclo [2.2.2] oct-7-ene-2,3,5,6-tetracarboxylic acid dianhydride, 5-(dioxotetrahydrofuryl-3-methyl-3-cyclohexene-1,2-dicarboxylic acid anhydride, 4-(2,5-dioxotetrahydrofuran-3-yl)-tetralin-1,2-dicarboxylic acid anhydride, tetrahydrofuran-2,3,4,5-tetracarboxylic acid dianhydride, bicyclo-3,3′,4,4′-tetracarboxylic acid dianhydride, 1,2,3,4-cyclopentane tetracarboxylic acid dianhydride, 1,2,3,4-cyclobutane tetracarboxylic acid dianhydride, 1,3-dimethyl-1,2,3,4-cyclobutane tetracarboxylic acid dianhydride, 1,4-dimethyl-1,2,3,4-cyclobutane tetracarboxylic acid dianhydride, and the like. From a point of view of availability of raw materials and imparting heat resistance and low double refraction to a nanosilica-containing polyimide containing the alicyclic tetracarboxylic acid dianhydride, the alicyclic tetracarboxylic acid dianhydride preferably has a structure selected from a group of structures represented by formulas (1)-(4), and two or more kinds may also be used. Further, from a point of view of imparting low thermal expansion to a nanosilica-containing polyimide containing the alicyclic tetracarboxylic acid dianhydride, the alicyclic tetracarboxylic acid dianhydride preferably has a structure represented by the formula (1) or (2). The formula (1) represents 1R, 2S, 4S, 5R-cyclohexane tetracarboxylic acid dianhydride; the formula (2) represents (1S, 2S, 4R, 5R)-cyclohexane tetracarboxylic acid dianhydride; the formula (3) represents 1,1′-bicyclo-3,3′,4,4′-tetracarboxylic acid dianhydride; and the formula (4) represents 1,2,3,4-cyclobutane tetracarboxylic acid dianhydride.

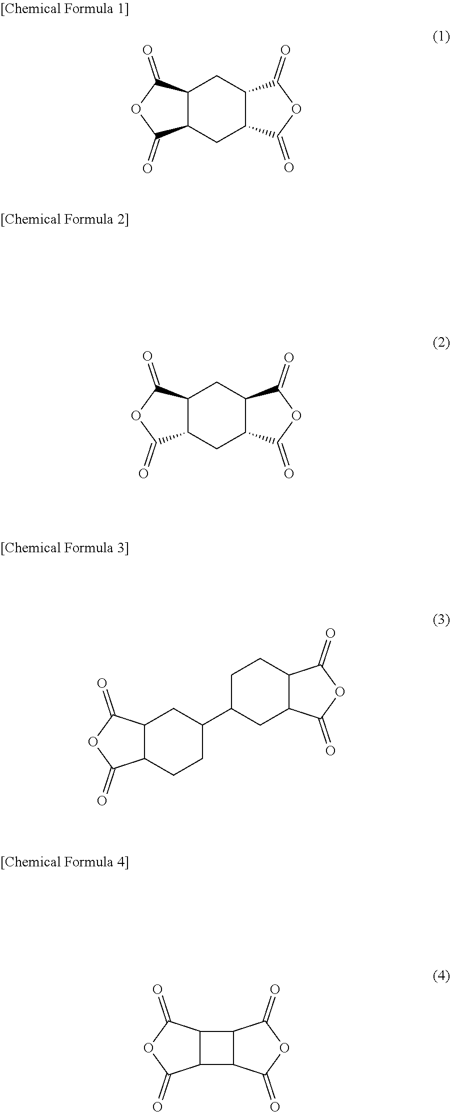 [SMILES: O=C1OC(=O)[C@@H]2C[C@H]3C(=O)OC(=O)[C@H]3C[C@H]12 ; O=C1OC(=O)[C@H]2C[C@H]3C(=O)OC(=O)[C@@H]3C[C@H]12 ; O=C1OC(=O)C2CC(C3CCC4C(=O)OC(=O)C4C3)CCC12 ; O=C1OC(=O)C2C1C1C(=O)OC(=O)C21]

Next, the aromatic diamine containing a carboxyl group is described. The aromatic diamine containing a carboxyl group in this specification means an aromatic diamine containing at least one carboxyl group. An aromatic diamine containing a carboxyl group may be used alone or two or more kinds of aromatic diamines each containing a carboxyl group may be used. From a point of view of availability of raw materials and heat resistance, the aromatic diamine containing a carboxyl group preferably has a structure selected from structures represented by a formula (5) or (6), and more preferably has a structure represented by the formula (5). The formula (5) represents a 3,5-diaminobenzoic acid; and the formula (6) represents a 5,5′-methylenebis (2-aminobenzoic acid).

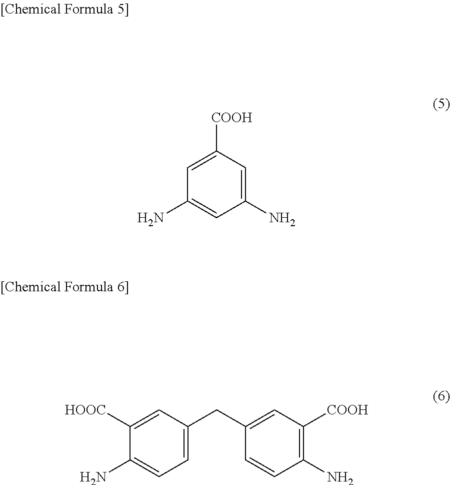 [SMILES: Nc1cc(N)cc(C(=O)O)c1 ; Nc1ccc(Cc2ccc(N)c(C(=O)O)c2)cc1C(=O)O]

From the above, it is more preferable that the alicyclic tetracarboxylic acid dianhydride has a structure represented by the formula (1), and the aromatic diamine containing a carboxyl group has a structure represented by the formula (5).

As a tetracarboxylic acid dianhydride component and a diamine component used in an embodiment of the present invention, in a range that characteristics are not affected, components other than the alicyclic tetracarboxylic acid dianhydride and the aromatic diamine containing a carboxyl group may also be included. The other tetracarboxylic acid dianhydride components are not particularly limited as long as the characteristics are not adversely affected. However, examples of the other tetracarboxylic acid dianhydride components include, but are limited to, pyromellitic acid dianhydride, 3,3′,4,4′-biphenyl tetracarboxylic acid dianhydride, 3,3′,4,4′-benzophenone tetracarboxylic acid dianhydride, 2,3,3′,4′-biphenyl tetracarboxylic acid dianhydride, 3,3′,4,4′-diphenylsulfone tetracarboxylic acid dianhydride, 1,4,5,8-naphthalene tetracarboxylic acid dianhydride, 2,3,6,7-naphthalene tetracarboxylic acid dianhydride, 1,2,5,6-naphthalene tetracarboxylic acid dianhydride, 4,4′-oxydiphthalic anhydride, 9,9-bis (3,4-dicarboxyphenyl) fluorene dianhydride, 9,9′-bis [4-(3,4-dicarboxyphenoxy) phenyl] fluorene dianhydride, 3,3′,4,4′-biphenyl ether tetracarboxylic acid dianhydride, 2,3,5,6-pyridine tetracarboxylic acid dianhydride, 3,4,9,10-perylene tetracarboxylic acid dianhydride, 4,4′-sulfonyl diphthalic acid dianhydride, para-terphenyl-3,4,3′,4′-tetracarboxylic acid dianhydride, meta-terphenyl-3,3′,4,4′-tetracarboxylic acid dianhydride 3,3′,4,4′-diphenyl ether tetracarboxylic acid dianhydride, and the like. From a point of view of imparting high transparency to a nanosilica-containing polyimide, among all tetracarboxylic acid dianhydride components, a ratio of the alicyclic tetracarboxylic acid dianhydride is preferably 30 mol % or more, more preferably 40 mol % or more, and even more preferably 50 mol % or more.

Examples of the other diamine components include, but are not limited to, 2,2′-bis (trifluoromethyl) benzidine, 4,4′-diaminobenzanilide, p-phenylenediamine, m-phenylenediamine, 3,4′-diaminodiphenyl ether, 4,4′-diaminodiphenyl ether, 4,4′-diaminodiphenyl sulfone, 9,9′-(4-aminophenyl) fluorene, 9,9′-(4-amino-3-methylphenyl) fluorene, 1,4′-bis (4-aminophenoxy) benzene, 2,2′-bis (4-aminophenoxyphenyl) propane, 4,4′-bis (4-aminophenoxy) biphenyl, 1,4-cyclohexanediamine, 4,4′-methylenebis (cyclohexanamine), 3,3-diamino-4,4-dihydroxydiphenylsulfone, 2,2-bis (3-amino-4-hydroxyphenyl) hexafluoropropane, and the like. From a point of view of imparting appropriate interaction between a polyamide acid or a polyimide and nanosilica, among all diamine components, a ratio of the aromatic diamine containing a carboxyl group is preferably 5 mol % or more, and more preferably 10 mol % or more.

The polyamide acid of an embodiment of the present invention can be synthesized using a commonly known general method, and can be obtained by causing a diamine and a tetracarboxylic acid dianhydride to react with each other in an organic solvent. Specifically, a diamine is dissolved or dispersed in a slurry form in an organic solvent in an inert gas such as an argon gas or a nitrogen gas to form a diamine solution. On the other hand, a tetracarboxylic acid dianhydride may be added to the diamine solution after being dissolved or dispersed in a slurry form in an organic solvent or in a solid state.

When a polyamide acid is synthesized using a diamine and a tetracarboxylic acid dianhydride, a polyamide acid copolymer can be arbitrarily obtained by adjusting a total number of moles of one kind of a diamine component alone or two or more kinds of diamine components and a total number of moles of one kind of a tetracarboxylic acid dianhydride component alone or two or more kinds of tetracarboxylic acid dianhydride components to be substantially equal. Further, by blending two or more kinds of polyamide acids, a polyamide acid containing two or more kinds of tetracarboxylic acid dianhydrides and two or more kinds of diamines can be obtained. A temperature condition for the above polymerization reaction of the diamine and the tetracarboxylic acid dianhydride, that is, the synthesis reaction of the polyamide acid, is not particularly limited. However, from a point of view of preventing a decrease in molecular weight of the synthesized polyamide acid, the temperature is preferably 80° C. or less, and the temperature is more preferably 0° C. or more and 50° C. or less in order to allow the polymerization reaction of the diamine and the tetracarboxylic acid dianhydride to appropriately proceed. Further, a reaction time may be arbitrarily set in a range of 10 minutes-30 hours.

An organic solvent used for the synthesis of the polyamide acid is preferably a solvent that dissolves the tetracarboxylic acid dianhydride and the diamine to be used, and is more preferably a solvent that dissolves the synthesized polyamide acid. Examples of the organic solvent include: urea-based solvents such as tetramethylurea and N,N-dimethylethylurea; sulfoxide or sulfone-based solvents such as dimethylsulfoxide, diphenylsulfone and tetramethylsulfone; amide-based solvents such as N,N-dimethylacetamide (DMAC), N,N-dimethylformamide (DMF), N,N′-diethylacetamide, N-methyl-2-pyrrolidone (NMP) and hexamethylphosphoric acid triamide; ester-based solvents such as γ-butyrolactone; halogenated alkyl-based solvents such as chloroform and methylene chloride; aromatic hydrocarbon-based solvents such as benzene and toluene; phenol-based solvents such as phenol and cresol; ketone-based solvents such as cyclopentanone; and ether-based solvents such as tetrahydrofuran, 1,3-dioxolane, 1,4-dioxane, dimethyl ether, diethyl ether and p-cresol methyl ether. Usually, these solvents are each used alone. However, when necessary, two or more of these solvents may be appropriately combined and used. In order to increase solubility and reactivity of the polyamide acid, the organic solvent is preferably selected from an amide-based solvent, a ketone-based solvent, an ester-based solvent and an ether-based solvent. An amide-based solvent such as DMF, DMAC or NMP is particularly preferable.

Next, the nanosilica is described. The nanosilica in an embodiment of the present invention refers to nano-sized silicon dioxide fine particles having an average particle size of 1 μm or less, and is not particularly limited in form and shape. From a point of view of imparting high transparency to the nanosilica-containing polyimide, the average particle size of the nanosilica is preferably 500 nm or less, more preferably 100 nm or less, and even more preferably 50 nm or less.

As a method for preparing the nanosilica-containing polyamide acid by compounding the polyamide acid and the nanosilica, a commonly known method can be used, and there is no particular limitation. As an example, a method of using an organosilica sol obtained by dispersing nanosilica in an organic solvent is described. As a method for compounding the polyamide acid and the organosilica sol, it is possible to synthesize the polyamide acid and the mix the synthesized polyamide acid and the organosilica sol. However, it is preferable to synthesize the polyamide acid in the organosilica sol because the nanosilica can be more highly dispersed in polyamide acid.

Further, the organosilica sol can also be subjected to a surface treatment to increase interaction with the polyamide acid. As a surface treatment agent, a commonly known surface treatment agent such as a silane coupling agent can be used. As the silane coupling agent, an alkoxysilane compound and the like having an amino group, a glycidyl group or the like as a functional group are widely known and can be appropriately selected. From a point of view of imparting interaction, an amino group-containing alkoxysilane is preferable. Examples of the amino group-containing alkoxysilane include 3-aminopropyltrimethoxysilane, 3-aminopropyltriethoxysilane, 3-aminopropylmethyldimethoxysilane, 3-aminopropylmethyldiethoxysilane, 3-(2-aminoethyl) aminopropyltrimethoxysilane, 3-phenylaminopropyltrimethoxysilane, 2-Aminophenyltrimethoxysilane, 3-aminophenyltrimethoxysilane, and the like. From a point of view of stability of raw materials, it is preferable to use 3-aminopropyltriethoxysilane. As a method of the surface treatment, a silane coupling agent is added to a dispersion liquid (organosilica sol), and the mixture can be caused to react by stirring the mixture for about 1-10 hours at 20-80° C. In this case, a catalyst or the like promoting the reaction may be added.

A content of the nanosilica of the nanosilica-containing polyamide acid with respect to 100 parts by weight of the polyamide acid is preferably 5 parts by weight or more and 50 parts by weight or less, and is more preferably 10 parts by weight or more and 45 parts by weight or less. When the content of the nanosilica is 5 parts by weight or more, thermal expansion and double refraction of the nanosilica-containing polyimide can be sufficiently lowered; and when the content of the nanosilica is 50 parts by weight or less, mechanical properties and transparency of the nanosilica-containing polyimide are not adversely affected.

A nanosilica-containing polyamide acid solution according to an embodiment of the present invention includes the nanosilica-containing polyamide acid and an organic solvent. Examples of the organic solvent include the above-described solvents that can be used for the synthesis of the polyamide acid solution.

Further, the nanosilica-containing polyimide according to an embodiment of the present invention includes a polyimide, which is an imidized product of the alicyclic tetracarboxylic acid dianhydride and the aromatic diamine containing a carboxyl group, and the nanosilica. A content of the nanosilica of the nanosilica-containing polyimide with respect to 100 parts by weight of the polyimide is preferably 5 parts by weight or more and 50 parts by weight or less, and is more preferably 10 parts by weight or more and 45 parts by weight or less. When the content of the nanosilica is 5 parts by weight or more, thermal expansion and double refraction of the nanosilica-containing polyimide can be sufficiently lowered; and when the content of the nanosilica is 50 parts by weight or less, mechanical properties and transparency of the nanosilica-containing polyimide are not adversely affected.

The nanosilica-containing polyimide may be synthesized using a commonly known method, and the method is not particularly limited. From a point of view of availability of raw materials and from a point of view of simplicity of synthesis of the nanosilica-containing polyimide, a method in which the nanosilica-containing polyimide is obtained by imidizing the above-described nanosilica-containing polyamide acid is preferable. In the following, a method in which the above-described nanosilica-containing polyamide acid is imidized is described.

Imidization from the nanosilica-containing polyamide acid to the nanosilica-containing polyimide can be performed in the same way as in a case where the nanosilica is not contained. That is, by subjecting the polyamide acid to dehydration ring closure, the polyamide acid can be imidized into the polyimide. The dehydration ring closure can be performed using an azeotropic method using an azeotropic solvent, a thermal method, or a chemical method. Further, a ratio of the imidization from the polyamide acid to the polyimide can be any ratio of 1-100%. That is, a partially imidized polyamide acid may be synthesized. In this specification, a solution containing a polyamide acid and an organic solvent is a polyamide acid solution. When the polyamide acid is obtained using the above-mentioned method, a synthesized reaction solution itself may also be expressed as a polyamide acid solution.

The dehydration ring closure of the polyamide acid can be performed by heating the polyamide acid. A method for heating the polyamide acid is not particularly limited. However, for example, a polyamide acid solution may be cast or applied to a substrate such as a glass plate, a silicon wafer, a metal plate such as a copper plate or an aluminum plate, or PET (polyethylene terephthalate), and thereafter, heat treatment may be performed within a temperature range of 80° C.-500° C. The substrate refers to a support, and hereinafter, a substrate in this specification is used to mean the same.

As a method for casting the polyamide acid solution on a substrate, a commonly known method can be used. Examples of commonly known casting methods include a gravure coating method, a spin coating method, a silk screen method, a dip coating method, a bar coating method, a knife coating method, a roll coating method, a die coating method, and the like.

Heating temperature and heating time for obtaining the polyimide by heating and imidizing (thermally imidizing) the polyamide acid solution can be appropriately determined and are not particularly limited as long as properties of the obtained polyimide are not affected.

The nanosilica-containing polyimide according to an embodiment of the present invention can be suitably used as a substrate material for a TFT substrate, a touch panel substrate, and the like. When the nanosilica-containing polyimide is used for the above application, a production method is often used in which a laminate of a substrate and the nanosilica-containing polyimide is produced and an electronic element is formed on the laminate, and finally the nanosilica-containing polyimide is peeled off. A nanosilica-containing polyimide laminate according to an embodiment of the present invention includes a substrate and the nanosilica-containing polyimide. In the following, a production method of the nanosilica-containing polyimide laminate and a production method of the nanosilica-containing polyimide via the nanosilica-containing polyimide laminate are specifically described. These are an example of the production method of the nanosilica-containing polyimide, and the present invention is not limited to the following.

First, it is preferable to cast a nanosilica-containing polyamide acid solution onto a substrate and heat the substrate and the nanosilica-containing polyamide acid solution at a temperature of 40-200° C. for 3-120 minutes. Further, for example, drying may be performed at temperatures of two stages such as at 50° C. for 30 minutes and subsequently at 100° C. for 30 minutes. Next, in order to allow imidization to proceed, the substrate and the nanosilica-containing polyamide acid solution are heated at a temperature of 200-400° C. for 3 minutes-300 minutes, and thereby the nanosilica-containing polyimide laminate can be obtained. In this case, it is preferable to gradually raise the temperature from a low temperature to a highest temperature. A rate of temperature rise is preferably 2° C./minute-10° C./minute, and more preferably 4° C./minute-10° C./minute. Further, the highest temperature is preferably in a temperature range of 250-400° C. When the highest temperature is 250° C. or more, imidization sufficiently proceeds. When the highest temperature is 400° C. or less, thermal degradation and coloring of the nanosilica-containing polyimide can be suppressed. Further, the substrate and the nanosilica-containing polyamide acid solution may be held at an arbitrary temperature for an arbitrary time until the highest temperature is reached. Heating can be performed under air, under a reduced pressure, or in an inert gas such as a nitrogen gas. However, in order to impart higher transparency to the nanosilica-containing polyimide, heating is preferably performed under a reduced pressure or in an inert gas such as a nitrogen gas. Further, as a heating device, a commonly known device such as a hot air oven, an infrared oven, a vacuum oven, an inert oven, a hot plate or the like can be used. Further, in order to shorten the heating time and to develop properties of the obtained nanosilica-containing polyimide laminate, an imidization agent or a dehydration catalyst may be added to the nanosilica-containing polyamide acid solution and this solution may be imidized by heating using a method as described above. A nanosilica-containing polyimide laminate can also be obtained in the same way from a partially imidized nanosilica-containing polyamide acid.

The imidizing agent is not particularly limited. However, a tertiary amine can be used. The tertiary amine is preferably a heterocyclic tertiary amine. Preferred specific examples of the heterocyclic tertiary amine include pyridine, picoline, quinoline, isoquinoline, and the like. Specific examples of the dehydration catalyst include acetic anhydride, propionic acid anhydride, n-butyric acid anhydride, benzoic acid anhydride, trifluoroacetic acid anhydride, and the like.

As a method for peeling off the nanosilica-containing polyimide from the obtained nanosilica-containing polyimide laminate, a commonly known method can be used. For example, peeling may be performed by hand or using mechanical devices such as a drive roll and a robot. Further, it is also possible to use a method in which a release layer is provided between the substrate and the nanosilica-containing polyimide, or a method in which a silicon oxide film is formed on a substrate having a large number of grooves and the nanosilica-containing polyimide is peeled off by infiltrating an etching solution. Further, a method in which the nanosilica-containing polyimide is separated by laser beam irradiation can also be used.

Although also depending an intended use of the nanosilica-containing polyamide acid, a weight average molecular weight of the nanosilica-containing polyamide acid according to an embodiment of the present invention is preferably in a range of 10,000 or more and 500,000 or less, more preferably in a range of 20,000-300,000, and even more preferably in a range of 30,000-200,000. When the weight average molecular weight is 10,000 or more, the nanosilica-containing polyamide acid and the nanosilica-containing polyimide can be used for a coating film or a film. On the other hand, when the weight average molecular weight is 500,000 or less, since sufficient solubility in a solvent is exhibited, a coating film or a film having a smooth surface and a uniform film thickness can be obtained from the nanosilica-containing polyamide acid solution and the nanosilica-containing polyimide to be described later. The term “weight average molecular weight” used here refers to a value of polyethylene glycol conversion by gel permeation chromatography (GPC).

The transparency of the nanosilica-containing polyimide is expressed, for example, using a total light transmittance or haze according to JIS K7105-1981. The total light transmittance of the nanosilica-containing polyimide is preferably 80% or more, and more preferably 85% or more. Further, the haze of the nanosilica-containing polyimide is preferably 2.0% or less, and more preferably 1.0% or less. In applications of the present invention, a light transmittance is required to be high in all wavelength regions. However, in general, a polyimide tends to easily absorb light on a short wavelength side, and the polyimide itself is often colored in yellow. In order to be used in applications of the present invention, when a film thickness is 10 μm, the light transmittance at a wavelength of 400 nm is preferably 60% or more, more preferably 65% or more, and even more preferably 70% or more.

Further, when the nanosilica-containing polyimide is peeled off from the nanosilica-containing polyimide laminate, a method is often used in which the substrate and the nanosilica-containing polyimide are peeled off by laser irradiation. From a point of view of processability of the peeling, the nanosilica-containing polyimide needs to absorb light of a wavelength of laser. A cutoff wavelength is preferably 310 nm or more, more preferably 320 nm or more, and even more preferably 330 nm or more.

Considering the above-described light transmittance, when the film thickness is 10 μm, the cutoff wavelength is preferably 310 nm or more and 390 nm or less, more preferably 320 nm or more and 385 nm or less, and even more preferably 330 nm or more and 380 nm or less.

The light transmittance of the nanosilica-containing polyimide at a wavelength of 400 nm means a light transmittance at a wavelength of 400 nm obtaining by measuring light transmittances in a wavelength range of 200-800 nm using an Ultraviolet-Visible Near-Infrared Spectrophotometer (V-650) manufactured by JASCO Corporation with respect to a nanosilica-containing polyimide having a film thickness of 10 μm. Further, a wavelength at which the light transmittance is 0.1% or less was taken as the cutoff wavelength of the nanosilica-containing polyimide.

The nanosilica-containing polyimide according to an embodiment of the present invention has, as film properties, low linear thermal expansion characteristics and dimensional stability before and after heating. For example, when these values are measured by performing thermal mechanical analysis (TMA) for the linear thermal expansion coefficient, after the film thickness of the nanosilica-containing polyimide is measured, the nanosilica-containing polyimide is cut to a size of 10 mm×3 mm to prepare a sample, and a load of 29.4 mN is applied to the sample, and after temperature is once raised at a rate of 10° C./minute from 10° C. to 300° C., the linear thermal expansion coefficient can be obtained from an amount of change in a strain of the sample per unit temperature in a temperature range of 100-250° C. during cooling when the temperature is lowered at 40° C./minute. From a point of view of having a linear thermal expansion coefficient equivalent to glass, the linear thermal expansion coefficient of the nanosilica-containing polyimide is preferably 50 ppm/K or less, more preferably −20 ppm/K or more and 50 ppm/K or less, even more preferably −10 ppm/K or more and 45 ppm/K or less, and particularly preferably −5 ppm/K or more and 40 ppm/K or less. In this specification, the linear thermal expansion coefficient refers to a linear thermal expansion coefficient in a temperature range of 100° C.-250° C. obtained using the above-described measurement method.

The nanosilica-containing polyimide according to an embodiment of the present invention preferably has a small double refraction as a film property. Since the polyimide contained in the nanosilica-containing polyimide is easy to orient in-plane, a difference in refractive index between a in-plane direction and a thickness direction (double refraction) is large, and, in particular, in a case of a polyimide having low thermal expansion, the double refraction is often large. In order to be used in applications of the present invention, when a maximum in-plane refractive index is defined as nx, a minimum in-plane refractive index is defined as ny, and a thickness direction refractive index is defined as nz,

nx−ny<0.0010 and (nx+ny)/2−nz<0.0150

are preferably satisfied, and, when higher optical isotropy is preferable,

nx−ny<0.0002 and (nx+ny)/2−nz<0.0100

are more preferably satisfied. Here, (nx+ny)/2−nz represents a difference in refractive index between an in-plane direction and the thickness direction, that is, the double refraction, and a smaller value of (nx+ny)/2−nz indicates a better optical isotropy.

The nanosilica-containing polyamide acid and the nanosilica-containing polyimide according to an embodiment of the present invention may be used as-is in coating and molding processes for producing products or members, and may also be used as a laminate for further processing such as coating on a molded product formed into a film-like shape. In order to be used in a coating or molding process, the nanosilica-containing polyamide acid and the nanosilica-containing polyimide may be dissolved or dispersed in a solvent as needed, and further, a photocurable component or a thermosetting component, a non-polymerizable binder resin other than the nanosilica-containing polyamide acid and the nanosilica-containing polyimide according to an embodiment of the present invention, or other components may be blended to prepare a composition containing the nanosilica-containing polyamide acid and the nanosilica-containing polyimide.

In order to impart processing properties and various functionalities to the nanosilica-containing polyamide acid and the nanosilica-containing polyimide according to an embodiment of the present invention, in addition to the nanosilica, various organic or inorganic low molecular or high molecular compounds may be blended. For example, a dye, a surfactant, a leveling agent, a plasticizer, fine particles, a sensitizer and the like can be used. The fine particles include organic fine particles of polystyrene, polytetrafluoroethylene, and the like, and inorganic particles of carbon, layered silicate and the like. These fine particles may have porous structures or hollow structures. Further, the fine particles can function as, for example, a pigment or a filler. The fine particles may be in a form of fibers or the like.

By using the nanosilica-containing polyimide laminate according to an embodiment of the present invention, a flexible device substrate having excellent characteristics can be obtained. That is, an electronic element can be formed on the nanosilica-containing polyimide contained in the nanosilica-containing polyimide laminate according to an embodiment of the present invention, and thereafter, by peeling off the nanosilica-containing polyimide from the substrate, a flexible device substrate can be obtained. The flexible device substrate according to an embodiment of the present invention includes the above-described nanosilica-containing polyimide and electronic element. Specifically, the flexible device substrate refers to: a flexible display substrate; a transparent conductive film substrate such as a TFT substrate and an ITO; a solar cell substrate; and the like. Further, the flexible device substrate (for example, a flexible display substrate) according to an embodiment of the present invention can be used for electronic devices such as an organic EL display, a liquid crystal display, electronic paper and a touch panel.

The nanosilica-containing polyimide according to an embodiment of the present invention is excellent in heat resistance, low thermal expansion and transparency, and also has characteristics such as low double refraction and excellent mechanical strength. The nanosilica-containing polyimide is preferably used for fields and products where these properties are effective, for example, for image display devices such as a printed matter, a color filter, a flexible display, an optical film, a liquid crystal display device, an organic EL and electronic paper, and for a 3-D display, a touch panel, a transparent conductive film substrate or a solar cell, and is more preferably used for as a substrate material of a portion where glass is currently used. That is, the nanosilica-containing polyamide acid and the nanosilica-containing polyimide according to an embodiment of the present invention can be particularly suitably used for substrates, image display devices, optical materials and electronic device materials, the nanosilica-containing polyamide acid containing a polyamide acid and nanosilica, the polyamide acid being obtained by causing an alicyclic tetracarboxylic acid dianhydride and an aromatic diamine containing a carboxyl group to react with each other. This substrate refers to a TFT substrate, an ITO substrate, a flexible display substrate, and the like. The image display device refers to an organic EL, electronic paper, a touch panel, and the like. This optical material refers to a color filter or the like.

The present invention is not limited to the above-described embodiments. Various modifications are possible within the scope of the claims. Embodiments obtained by appropriately combining technical means respectively disclosed in different embodiments are also included in the technical scope of the present invention. Further, by combining technical means that are respectively disclosed in the embodiments, new technical features can be formed.

The present invention can include the following aspects.

(1) A nanosilica-containing polyamide acid includes: a polyamide acid that is a polymer of an alicyclic tetracarboxylic acid dianhydride and an aromatic diamine containing a carboxyl group; and nanosilica.

(2) In the nanosilica-containing polyamide acid described in the above aspect (1), the alicyclic tetracarboxylic acid dianhydride has a structure selected from a group of structures represented by formulas (1)-(4).

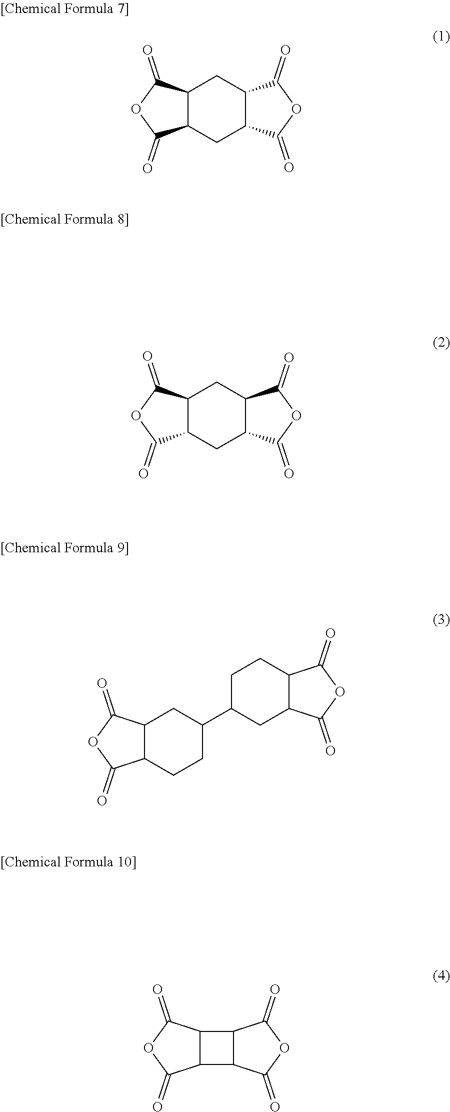 [SMILES: O=C1OC(=O)[C@@H]2C[C@H]3C(=O)OC(=O)[C@H]3C[C@H]12 ; O=C1OC(=O)[C@H]2C[C@H]3C(=O)OC(=O)[C@@H]3C[C@H]12 ; O=C1OC(=O)C2CC(C3CCC4C(=O)OC(=O)C4C3)CCC12 ; O=C1OC(=O)C2C1C1C(=O)OC(=O)C21]

(3) In the nanosilica-containing polyamide acid described in the above aspect (1) or (2), of the aromatic diamine containing a carboxyl group, at least one kind is a diamine having a structure represented by a formula (5) or (6).

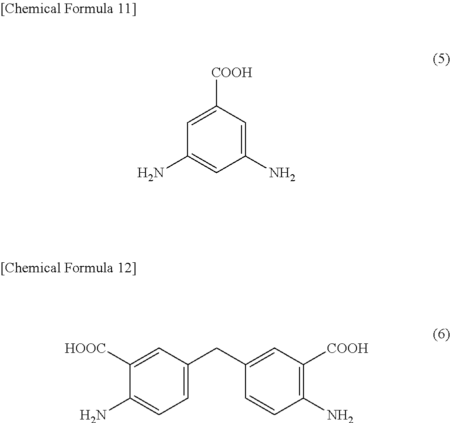 [SMILES: Nc1cc(N)cc(C(=O)O)c1 ; Nc1ccc(Cc2ccc(N)c(C(=O)O)c2)cc1C(=O)O]

(4) In the nanosilica-containing polyamide acid described in any one of the above aspects (1)-(3), the alicyclic tetracarboxylic acid dianhydride has a structure represented by the following formula (1), and the aromatic diamine containing a carboxyl group has a structure represented by the following formula (5).

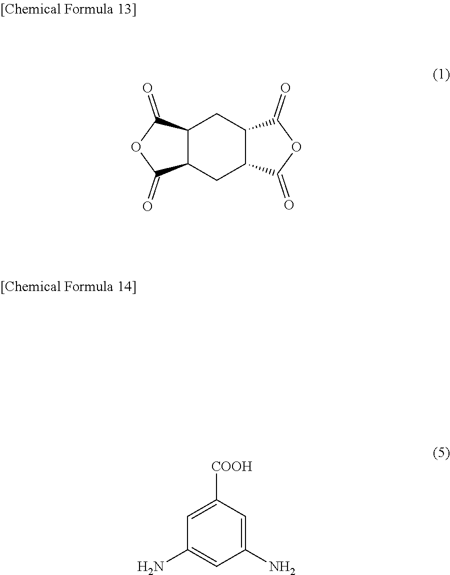 [SMILES: O=C1OC(=O)[C@@H]2C[C@H]3C(=O)OC(=O)[C@H]3C[C@H]12 ; Nc1cc(N)cc(C(=O)O)c1]

(5) In the nanosilica-containing polyamide acid described in any one of the above aspects (1)-(4), a content of the nanosilica with respect to 100 parts by weight of the polyamide acid is 5 parts by weight or more and 50 parts by weight or less.

(6) A nanosilica-containing polyamide acid solution contains: the nanosilica-containing polyamide acid according to any one of the above aspects (1)-(5); and an organic solvent.

(7) A nanosilica-containing polyimide includes: a polyimide that is an imidized product of an alicyclic tetracarboxylic acid dianhydride and an aromatic diamine containing a carboxyl group; and nanosilica.

(8) In the nanosilica-containing polyamide described in the above aspect (7), the alicyclic tetracarboxylic acid dianhydride has a structure selected from a group of structures represented by formulas (1)-(4).

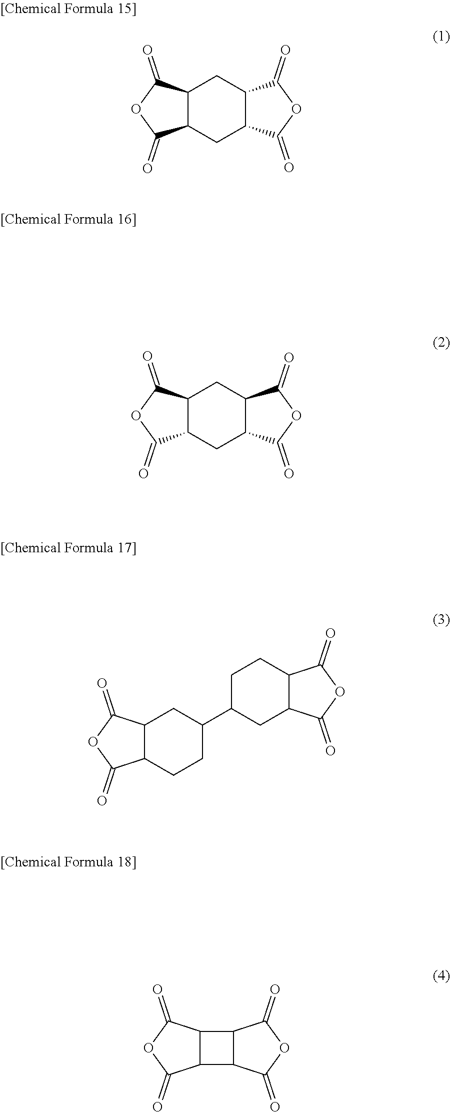 [SMILES: O=C1OC(=O)[C@@H]2C[C@H]3C(=O)OC(=O)[C@H]3C[C@H]12 ; O=C1OC(=O)[C@H]2C[C@H]3C(=O)OC(=O)[C@@H]3C[C@H]12 ; O=C1OC(=O)C2CC(C3CCC4C(=O)OC(=O)C4C3)CCC12 ; O=C1OC(=O)C2C1C1C(=O)OC(=O)C21]

(9) In the nanosilica-containing polyamide described in the above aspect (7) or (8), of the aromatic diamine containing a carboxyl group, at least one kind has a structure represented by a formula (5) or (6).

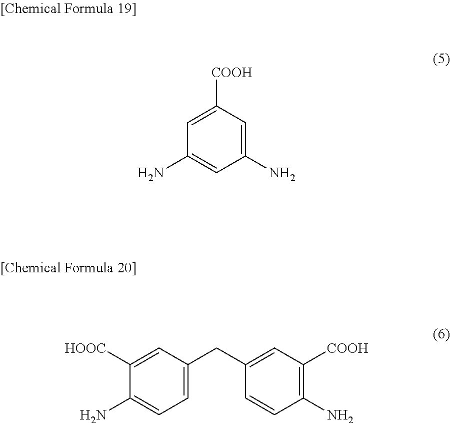 [SMILES: Nc1cc(N)cc(C(=O)O)c1 ; Nc1ccc(Cc2ccc(N)c(C(=O)O)c2)cc1C(=O)O]

(10) In the nanosilica-containing polyamide described in any one of the above aspects (7)-(9), the alicyclic tetracarboxylic acid dianhydride has a structure represented by the following formula (1), and the aromatic diamine containing a carboxyl group has a structure represented by the following formula (5).

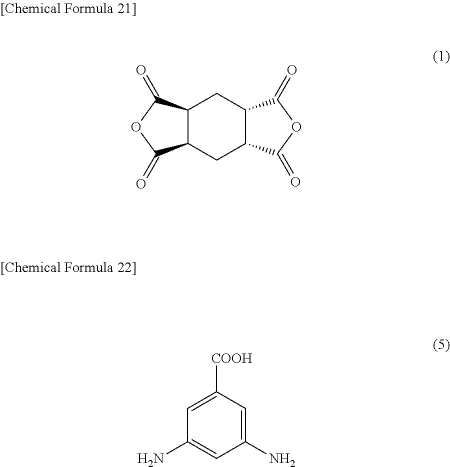 [SMILES: O=C1OC(=O)[C@@H]2C[C@H]3C(=O)OC(=O)[C@H]3C[C@H]12 ; Nc1cc(N)cc(C(=O)O)c1]

(11) In the nanosilica-containing polyamide described in any one of the above aspects (7)-(10), a content of the nanosilica with respect to 100 parts by weight of the polyimide is 5 parts by weight or more and 50 parts by weight or less.

(12) In the nanosilica-containing polyamide described in any one of the above aspects (7)-(11), when a film thickness is 10 μm, a light transmittance at a wavelength of 400 nm is 60% or more.

(13) In the nanosilica-containing polyamide described in any one of the above aspects (7)-(12), when a film thickness is 10 μm, a cutoff wavelength is 310 nm or more and 390 nm or less.

(14) In the nanosilica-containing polyamide described in any one of the above aspects (7)-(13), when a film thickness is 10 μm, a linear thermal expansion coefficient at 100-250° C. is 50 ppm/K or less.

(15) In the nanosilica-containing polyamide described in any one of the above aspects (7)-(14), when a maximum in-plane refractive index is nx, a minimum in-plane refractive index is ny, and a thickness direction refractive index is nz, relations nx−ny<0.0010 and (nx+ny)/2−nz<0.0150 are satisfied.

(16) A nanosilica-containing polyimide laminate includes: a substrate; and the nanosilica-containing polyimide according to any one of the above aspects (7)-(15).

(17) A production method of a nanosilica-containing polyimide laminate includes: a process of casting the nanosilica-containing polyamide acid according to any one of the above aspects (1)-(5) onto a substrate; and a process of thermally imidizing the nanosilica-containing polyamide acid.

(18) A production method of a nanosilica-containing polyimide includes: a process of casting the nanosilica-containing polyamide acid solution according to the above aspect (6) onto a substrate; a process of thermally imidizing the nanosilica-containing polyamide acid solution; and a process of peeling off a nanosilica-containing polyimide obtained in a process after the thermal imidization.

(19) A production method of a flexible device substrate includes a process of forming an electronic element on a polyimide obtained from the nanosilica-containing polyamide acid according to any one of the above aspect (1)-(5).

(20) A production method of a flexible device substrate includes: a process of casting the nanosilica-containing polyamide acid according to any one of the above aspect (1)-(5) onto a substrate; a process of thermally imidizing the nanosilica-containing polyamide acid; and a process of forming an electronic element on a thermally imidized polyimide.

(21) A production method of a flexible device substrate includes: a process of casting the nanosilica-containing polyamide acid according to any one of the above aspect (1)-(5) onto a substrate; a process of thermally imidizing the nanosilica-containing polyamide acid; and a process of forming an electronic element on a thermally imidized polyimide and peeling off the electronic element and the polyimide from the substrate.

(22) A flexible device substrate includes: the nanosilica-containing polyimide according to any one of the above aspect (7)-(15); and an electronic element.

### EXAMPLES

### (Evaluation Method)

Evaluation values and the like of physical properties described in in this specification were obtained using the following evaluation method.

### (1) Weight Average Molecular Weight of Polyamide Acid

The weight average molecular weight (Mw) was obtained under the conditions of Table 1. Evaluation results are shown in Table 2.

TABLE 1

| Item | Molecular weight measuring device condition |
|---|---|
| Device | CO-8020, SD-8022, DP-8020, AS-8020, RI-8020 |
| | (all manufactured by Tosoh Corporation) |
| Column | Shodex: GPC KD-806M × 2 |
| Column size | Each 8 mmΦ × 30 cm, total 60 cm |
| | Guard column (GPC KD-G) 4.6 mmΦ × 1 cm |
| Column | 40° C. |
| temperature | |
| Eluent | 30 mM LiBr + 30 mM phosphate/ |
| | DMF |
| Flow rate | 0.6 mL/minute |
| Injection | about 1.3-1.7 MPa |
| pressure | |
| Injection | 30 μL (solid content concentration: 0.4% by weight) |
| volume | |
| Standard | Polyethylene oxide |
| sample | (used for preparation of calibration curve) |
| Detector | RI |
| Calibration | One dimension |
| curve order | |

### (2) Light Transmittance of Polyimide Film

The light transmittance at 200-800 nm of the polyimide film was measured using a Ultraviolet-Visible Near Infrared Spectrophotometer (V-650) manufactured by JASCO Corporation, and the light transmittance at a wavelength of 400 nm was used as an indicator of the light transmittance of the polyimide. A wavelength (cutoff wavelength) at which the light transmittance is 0.1% or less was also determined.

### (3) Linear Thermal Expansion Coefficient (CTE) of Polyimide Film

For the measurement of the linear thermal expansion coefficient of the polyimide film, TMA/SS7100 manufactured by Hitachi High-Tech Science Co., Ltd. was used (sample size: width: 3 mm. length: 10 mm; a film thickness was measured, and a cross-sectional area of the sample was calculated), a load was 29.4 mN, and, after the temperature was once raised at a rate of 10° C./minute from 10° C. to 300° C., the linear thermal expansion coefficient was obtained from an amount of change in a strain of the sample per unit temperature in a temperature range of 100-250° C. during cooling when the temperature was lowered at 40° C./minute.

### (4) Total Light Transmittance of Polyimide Film

Measurement was performed according to a method described in JIS K7105-1981 using an Integrating sphere type haze meter 300A manufactured by Nippon Denshoku Industries,

### (5) Haze of Polyimide Film

Measurement was performed according to a method described in JIS K7105-1981 using an Integrating sphere type haze meter 300A manufactured by Nippon Denshoku Industries,

### (6) Phase Difference Measurement

Values of a front phase difference and a thickness phase difference at a measurement wavelength of 590 nm were measured using a phase difference meter: OPTIPRO manufactured by Shintech Corporation. Using the values, nx−ny and (nx+ny)/2−nz were calculated. Here, nx, ny and nz were respectively defined as a maximum in-plane refractive index (nx), a minimum in-plane refractive index (ny) and a thickness direction refractive index (nz).

### Example 1

### <Synthesis of Nanosilica-Containing Polyamide Acid Solution>

32.0 g of organosilica sol: NMP-ST-R2 (manufactured by Nissan Chemical Industries, Ltd., dispersion medium: NMP; nanosilica content: 30 parts by weight; average particle size: 10-15 nm) and 64.0 g of NMP were charged into a 500 mL glass separable flask equipped with a stirrer (having a stainless steel stirring bar) and a nitrogen inlet tube, and the mixture was stirred. Thereafter, 9.6 g of a 1% NMP solution of 3-aminopropyltriethoxysilane (hereinafter may also be referred to as γ-APS) was added and the mixture was stirred at 25° C. for 1 hour to perform a surface treatment of nanosilica. 9.7 g of 3,5-diaminobenzoic acid (hereinafter may also be referred to as 3,5-DABA) was added to this solution and was dissolved by stirring. Thereafter, 14.3 g of 1R, 2S, 4S, 5R-cyclohexane tetracarboxylic acid dianhydride (hereinafter may also be referred to as PMDA-HS) was further added and the mixture was stirred for 12 hours to obtain a nanosilica-containing polyamide acid solution (reaction solution). When the entire diamine component is 100 mol %, charge ratios of the monomers are as follows: PMDA-HS: 100 mol %, and 3,5-DABA: 100 mol %, and the content of the nanosilica with respect to 100 parts by weight of the polyamide acid is 40 parts by weight. A charge concentration of the diamine component and the tetracarboxylic acid dianhydride component in this reaction solution was 18.5% by weight with respect to the entire reaction solution.

### <Preparation of Nanosilica-Containing Polyimide Film>

The obtained polyamide acid solution was cast on a square alkali-free glass plate (Eagle XG manufactured by Corning Incorporated) having sides of 150 mm and a thickness of 0.7 mm using a bar coater such that a thickness after drying was 10 μm, and was dried in a hot air oven at 80° C. for 30 minutes. Thereafter, the temperature was raised at a rate of 5° C./minute from 20° C. to 350° C. under a nitrogen atmosphere, heating was performed at 350° C. for 1 hour, and a laminate of a nanosilica-containing polyimide film (of which a polyimide has a thickness of 10 μm) and a glass plate was obtained. The nanosilica-containing polyimide film was peeled off from the glass plate, and physical properties of the nanosilica-containing polyimide film were evaluated. Evaluation results are shown in Table 2.

### [Table 2]

### Example 2

### <Synthesis of Nanosilica-Containing Polyamide Acid Solution>

32.0 g of organosilica sol: NMP-ST-R2 and 64.0 g of NMP were charged into a 500 mL glass separable flask equipped with a stirrer (having a stainless steel stirring bar) and a nitrogen inlet tube, and the mixture was stirred. Thereafter, 9.6 g of a 1% NMP solution of γ-APS was added and the mixture was stirred at 25° C. for 1 hour to perform a surface treatment of nanosilica. 4.4 g of 3,5-DABA was added to this solution and was dissolved by stirring, and thereafter, 6.6 g of 4,4′-diaminobenzanilide (hereinafter may also be referred to as DABA) was added and the mixture was stirred for 1 hour. Thereafter, 13.0 g of PMDA-HS was added and the mixture was stirred for 12 hours to obtain a nanosilica-containing polyamide acid solution (reaction solution). When the entire diamine component is 100 mol %, charge ratios of the monomers are as follows: PMDA-HS: 100 mol %, 3,5-DABA: 50 mol %, and DABA: 50 mol %, and the content of the nanosilica with respect to 100 parts by weight of the polyamide acid is 40 parts by weight. A charge concentration of the diamine compound and the tetracarboxylic acid dianhydride in this reaction solution was 18.5% by weight with respect to the entire reaction solution.

### <Preparation of Nanosilica-Containing Polyimide Film>

The obtained polyamide acid solution was cast on a square alkali-free glass plate (Eagle XG manufactured by Corning Incorporated) having sides of 150 mm and a thickness of 0.7 mm using a bar coater such that a thickness after drying was 10 μm, and was dried in a hot air oven at 80° C. for 30 minutes. Thereafter, the temperature was raised at a rate of 5° C./minute from 20° C. to 350° C. under a nitrogen atmosphere, heating was performed at 350° C. for 1 hour, and a laminate of a nanosilica-containing polyimide film (of which a polyimide has a thickness of 10 μm) and a glass plate was obtained. The nanosilica-containing polyimide film was peeled off from the glass plate, and physical properties of the nanosilica-containing polyimide film were evaluated. Evaluation results are shown in Table 2.

### Example 3

### <Synthesis of Nanosilica-Containing Polyamide Acid Solution>

32.0 g of organosilica sol: NMP-ST-R2 and 64.0 g of NMP were charged into a 500 mL glass separable flask equipped with a stirrer (having a stainless steel stirring bar) and a nitrogen inlet tube, and the mixture was stirred. Thereafter, 9.6 g of a 1% NMP solution of γ-APS was added and the mixture was stirred at 25° C. for 1 hour to perform a surface treatment of nanosilica. 1.7 g of 3,5-DABA was added to this solution and was dissolved, and thereafter, 10.0 g of DABA was added and the mixture was stirred for 1 hour. Thereafter, 12.3 g of PMDA-HS was added and the mixture was stirred for 12 hours to obtain a nanosilica-containing polyamide acid solution (reaction solution). When the entire diamine component is 100 mol %, charge ratios of the monomers are as follows: PMDA-HS: 100 mol %, 3,5-DABA: 20 mol %, and DABA: 80 mol %, and the content of the nanosilica with respect to 100 parts by weight of the polyamide acid is 40 parts by weight. A charge concentration of the diamine compound and the tetracarboxylic acid dianhydride in this reaction solution was 18.5% by weight with respect to the entire reaction solution.

### <Preparation of Nanosilica-Containing Polyimide Film>

The obtained polyamide acid solution was cast on a square alkali-free glass plate (Eagle XG manufactured by Corning Incorporated) having sides of 150 mm and a thickness of 0.7 mm using a bar coater such that a thickness after drying was 10 μm, and was dried in a hot air oven at 80° C. for 30 minutes. Thereafter, the temperature was raised at a rate of 5° C./minute from 20° C. to 350° C. under a nitrogen atmosphere, heating was performed at 350° C. for 1 hour, and a laminate of a nanosilica-containing polyimide film (of which a polyimide has a thickness of 10 μm) and a glass plate was obtained. The nanosilica-containing polyimide film was peeled off from the glass plate, and physical properties of the nanosilica-containing polyimide film were evaluated. Evaluation results are shown in Table 2.

### Example 4

### <Synthesis of Nanosilica-Containing Polyamide Acid Solution>

24.0 g of organosilica sol: NMP-ST-R2 and 72.0 g of NMP were charged into a 500 mL glass separable flask equipped with a stirrer (having a stainless steel stirring bar) and a nitrogen inlet tube, and the mixture was stirred. Thereafter, 7.2 g of a 1% NMP solution of γ-APS was added and the mixture was stirred at 25° C. for 1 hour to perform a surface treatment of nanosilica. 1.7 g of 3,5-DABA was added to this solution and was dissolved by stirring, and thereafter, 10.0 g of DABA was added and the mixture was stirred for 1 hour. Thereafter, 12.3 g of PMDA-HS was added and the mixture was stirred for 12 hours to obtain a nanosilica-containing polyamide acid solution (reaction solution). When the entire diamine component is 100 mol %, charge ratios of the monomers are as follows: PMDA-HS: 100 mol %, 3,5-DABA: 20 mol %, and DABA: 80 mol %, and the content of the nanosilica with respect to 100 parts by weight of the polyamide acid is 30 parts by weight. A charge concentration of the diamine compound and the tetracarboxylic acid dianhydride in this reaction solution was 19.0% by weight with respect to the entire reaction solution.

### <Preparation of Nanosilica-Containing Polyimide Film>

The obtained polyamide acid solution was cast on a square alkali-free glass plate (Eagle XG manufactured by Corning Incorporated) having sides of 150 mm and a thickness of 0.7 mm using a bar coater such that a thickness after drying was 10 μm, and was dried in a hot air oven at 80° C. for 30 minutes. Thereafter, the temperature was raised at a rate of 5° C./minute from 20° C. to 350° C. under a nitrogen atmosphere, heating was performed at 350° C. for 1 hour, and a laminate of a nanosilica-containing polyimide film (of which a polyimide has a thickness of 10 μm) and a glass plate was obtained. The nanosilica-containing polyimide film was peeled off from the glass plate, and physical properties of the nanosilica-containing polyimide film were evaluated. Evaluation results are shown in Table 2.

### Example 5

### <Synthesis of Nanosilica-Containing Polyamide Acid Solution>

32.0 g of organosilica sol: NMP-ST-R2 and 64.0 g of NMP were charged into a 500 mL glass separable flask equipped with a stirrer (having a stainless steel stirring bar) and a nitrogen inlet tube, and the mixture was stirred. Thereafter, 9.6 g of a 1% NMP solution of γ-APS was added and the mixture was stirred at 25° C. for 1 hour to perform a surface treatment of nanosilica. 1.6 g of 3,5-DABA was added to this solution and was dissolved by stirring, and thereafter, 9.4 g of DABA was added and the mixture was stirred for 1 hour. Thereafter, 5.5 g of 1,1′-bicyclohexane-3.3′4.4′-tetracarboxylic acid dianhydride (hereinafter may also be referred to as HBPDA) was added and teh mixture was stirred for 10 minutes, and thereafter, 7.5 g of PMDA-HS was added and the mixture was stirred for 12 hours to obtain a nanosilica-containing polyamide acid solution (reaction solution). When the entire diamine component is 100 mol %, charge ratios of the monomers are as follows: PMDA-HS: 65 mol %, HBPDA: 35 mol %, 3,5-DABA: 20 mol %, and DABA: 80 mol %, and the content of the nanosilica with respect to 100 parts by weight of the polyamide acid is 40 parts by weight. A charge concentration of the diamine compound and the tetracarboxylic acid dianhydride in this reaction solution was 18.5% by weight with respect to the entire reaction solution.

### <Preparation of Nanosilica-Containing Polyimide Film>

The obtained polyamide acid solution was cast on a square alkali-free glass plate (Eagle XG manufactured by Corning Incorporated) having sides of 150 mm and a thickness of 0.7 mm using a bar coater such that a thickness after drying was 10 μm, and was dried in a hot air oven at 80° C. for 30 minutes. Thereafter, the temperature was raised at a rate of 5° C./minute from 20° C. to 350° C. under a nitrogen atmosphere, heating was performed at 350° C. for 1 hour, and a laminate of a nanosilica-containing polyimide film (of which a polyimide has a thickness of 10 μm) and a glass plate was obtained. The nanosilica-containing polyimide film was peeled off from the glass plate, and physical properties of the nanosilica-containing polyimide film were evaluated. Evaluation results are shown in Table 2.

### Example 6

### <Synthesis of Nanosilica-Containing Polyamide Acid Solution>

24.0 g of organosilica sol: NMP-ST-R2 and 72.0 g of NMP were charged into a 500 mL glass separable flask equipped with a stirrer (having a stainless steel stirring bar) and a nitrogen inlet tube, and the mixture was stirred. Thereafter, 7.2 g of a 1% NMP solution of γ-APS was added and the mixture was stirred at 25° C. for 1 hour to perform a surface treatment of nanosilica. 2.4 g of 3,5-DABA was added to this solution and was dissolved by stirring, and thereafter, 8.3 g of DABA was added and the mixture was stirred for 1 hour. Thereafter, 5.6 g of HBPDA was added and the mixture was stirred for 10 minutes, and thereafter, 7.6 g of PMDA-HS was added and the mixture was stirred for 12 hours to obtain a nanosilica-containing polyamide acid solution (reaction solution). When the entire diamine component is 100 mol %, charge ratios of the monomers are as follows: PMDA-HS: 65 mol %, HBPDA: 35 mol %, 3,5-DABA: 30 ml %, and DABA: 70 mol %, and the content of the nanosilica with respect to 100 parts by weight of the polyamide acid is 30 parts by weight. A charge concentration of the diamine compound and the tetracarboxylic acid dianhydride in this reaction solution was 19.0% by weight with respect to the entire reaction solution.

### <Preparation of Nanosilica-Containing Polyimide Film>

The obtained polyamide acid solution was cast on a square alkali-free glass plate (Eagle XG manufactured by Corning Incorporated) having sides of 150 mm and a thickness of 0.7 mm using a bar coater such that a thickness after drying was 10 μm, and was dried in a hot air oven at 80° C. for 30 minutes. Thereafter, the temperature was raised at a rate of 5° C./minute from 20° C. to 350° C. under a nitrogen atmosphere, heating was performed at 350° C. for 1 hour, and a laminate of a nanosilica-containing polyimide film (of which a polyimide has a thickness of 10 μm) and a glass plate was obtained. The nanosilica-containing polyimide film was peeled off from the glass plate, and physical properties of the nanosilica-containing polyimide film were evaluated. Evaluation results are shown in Table 2.

### Comparative Example 1

### <Synthesis of Polyamide Acid Solution>

106.7 g of NMP was charged into a 500 mL glass separable flask equipped with a stirrer (having a stainless steel stirring bar) and a nitrogen inlet tube, and 9.7 g of 3,5-DABA was added and dissolved by stirring, and thereafter, 14.3 g of PMDA-HS was further added and the mixture was stirred for 12 hours to obtain a polyamide acid solution (reaction solution). When the entire diamine component is 100 mol %, charge ratios of the monomers are as follows: PMDA-HS: 100 mol %, and 3,5-DABA: 100 mol %, and a charge concentration of the diamine component and the tetracarboxylic acid dianhydride component in this reaction solution was 18.5% by weight with respect to the entire reaction solution.

### <Preparation of Polyimide Film>

The obtained polyamide acid solution was cast on a square alkali-free glass plate (Eagle XG manufactured by Corning Incorporated) having sides of 150 mm and a thickness of 0.7 mm using a bar coater such that a thickness after drying was 10 μm, and was dried in a hot air oven at 80° C. for 30 minutes. Thereafter, the temperature was raised at a rate of 5° C./minute from 20° C. to 350° C. under a nitrogen atmosphere, heating was performed at 350° C. for 1 hour, and a laminate of a polyimide film (of which a polyimide has a thickness of 10 μm) and a glass plate was obtained. The polyimide film was peeled off from the glass plate, and physical properties of the polyimide film were evaluated. Evaluation results are shown in Table 2.

### Comparative Example 2

### <Synthesis of Polyamide Acid Solution>

106.7 g of NMP was charged into a 500 mL glass separable flask equipped with a stirrer (having a stainless steel stirring bar) and a nitrogen inlet tube, and 1.7 g of 3,5-DABA was added and dissolved by stirring, and thereafter, 10.0 g of DABA was added and the mixture was stirred for 1 hour. Thereafter, 12.3 g of PMDA-HS was added and the mixture was stirred for 12 hours to obtain a polyamide acid solution (reaction solution). When the entire diamine component is 100 mol %, charge ratios of the monomers are as follows: PMDA-HS: 100 mol %, 3,5-DABA: 20 ml %, and DABA: 80 mol %, and a charge concentration of the diamine compound and the tetracarboxylic acid dianhydride in this reaction solution was 18.5% by weight with respect to the entire reaction solution.

### <Preparation of Polyimide Film>

The obtained polyamide acid solution was cast on a square alkali-free glass plate (Eagle XG manufactured by Corning Incorporated) having sides of 150 mm and a thickness of 0.7 mm using a bar coater such that a thickness after drying was 10 μm, and was dried in a hot air oven at 80° C. for 30 minutes. Thereafter, the temperature was raised at a rate of 5° C./minute from 20° C. to 350° C. under a nitrogen atmosphere, heating was performed at 350° C. for 1 hour, and a laminate of a polyimide film (of which a polyimide has a thickness of 10 μm) and a glass plate was obtained. The polyimide film was peeled off from the glass plate, and physical properties of the polyimide film were evaluated. Evaluation results are shown in Table 2.

### Comparative Example 3

### <Synthesis of Polyamide Acid Solution>

106.7 g of NMP was charged into a 500 mL glass separable flask equipped with a stirrer (having a stainless steel stirring bar) and a nitrogen inlet tube, and 12.1 g of DABA was added and the mixture was stirred for 1 hour, and thereafter, 12.0 g of PMDA-HS was further added and the mixture was stirred for 12 hours to obtain a polyamide acid solution (reaction solution). When the entire diamine component is 100 mol %, charge ratios of the monomers are as follows: PMDA-HS: 100 mol % and DABA: 100 mol %, and a charge concentration of the diamine component and the tetracarboxylic acid dianhydride component in this reaction solution was 18.5% by weight with respect to the entire reaction solution.

### <Preparation of Polyimide Film>

The obtained polyamide acid solution was cast on a square alkali-free glass plate (Eagle XG manufactured by Corning Incorporated) having sides of 150 mm and a thickness of 0.7 mm using a bar coater such that a thickness after drying was 10 μm, and was dried in a hot air oven at 80° C. for 30 minutes. Thereafter, the temperature was raised at a rate of 5° C./minute from 20° C. to 350° C. under a nitrogen atmosphere, heating was performed at 350° C. for 1 hour, and a laminate of a polyimide film (of which a polyimide has a thickness of 10 μm) and a glass plate was obtained. The polyimide film was peeled off from the glass plate, and physical properties of the polyimide film were evaluated. Evaluation results are shown in Table 2.

### Comparative Example 4

### <Synthesis of Nanosilica-Containing Polyamide Acid Solution>

32.0 g of organosilica sol: NMP-ST-R2 and 64.0 g of NMP were charged into a 500 mL glass separable flask equipped with a stirrer (having a stainless steel stirring bar) and a nitrogen inlet tube, and the mixture was stirred. Thereafter, 9.6 g of a 1% NMP solution of γ-APS was added and the mixture was stirred at 25° C. for 1 hour to perform a surface treatment of nanosilica. 12.1 g of DABA was added to this solution and the mixture was stirred for 1 hour, and thereafter, 12.0 g of PMDA-HS was further added and the mixture was stirred for 12 hours to obtain a nanosilica-containing polyamide acid solution (reaction solution). When the entire diamine component is 100 mol %, charge ratios of the monomers are as follows: PMDA-HS: 100 mol %, and DABA: 100 mol %, and the content of the nanosilica with respect to 100 parts by weight of the polyamide acid is 40 parts by weight. A charge concentration of the diamine component and the tetracarboxylic acid dianhydride component in this reaction solution was 18.5% by weight with respect to the entire reaction solution.

### <Preparation of Nanosilica-Containing Polyimide Film>

The obtained polyamide acid solution was cast on a square alkali-free glass plate (Eagle XG manufactured by Corning Incorporated) having sides of 150 mm and a thickness of 0.7 mm using a bar coater such that a thickness after drying was 10 μm, and was dried in a hot air oven at 80° C. for 30 minutes. Thereafter, the temperature was raised at a rate of 5° C./minute from 20° C. to 350° C. under a nitrogen atmosphere, heating was performed at 350° C. for 1 hour, and a laminate of a nanosilica-containing polyimide film (of which a polyimide has a thickness of 10 μm) and a glass plate was obtained. The nanosilica-containing polyimide film was peeled off from the glass plate, and physical properties of the nanosilica-containing polyimide film were evaluated. Evaluation results are shown in Table 2.

### Comparative Example 5

### <Synthesis of Nanosilica-Containing Polyamide Acid Solution>

48.0 g of organosilica sol: DMAC-ST (manufactured by Nissan Chemical Industries, Ltd., dispersion medium: N,N-dimethylacetamide; nanosilica content: 20 parts by weight; average particle size: 10-15 nm) and 48.0 g of NMP were charged into a 500 mL glass separable flask equipped with a stirrer (having a stainless steel stirring bar) and a nitrogen inlet tube, and the mixture was stirred. Thereafter, 9.6 g of a 1% NMP solution of γ-APS was added and the mixture was stirred at 25° C. for 1 hour to perform a surface treatment of nanosilica. 11.3 g of 4,4′-diaminodiphenyl ether (hereinafter may also be referred to as 4,4′-ODA) was added to this solution and the mixture was stirred for 1 hour, and thereafter, 12.6 g of PMDA-HS was further added and the mixture was stirred for 12 hours to obtain a nanosilica-containing polyamide acid solution (reaction solution). When the entire diamine component is 100 mol %, charge ratios of the monomers are as follows: PMDA-HS: 100 mol %, and 4,4′-ODA: 100 mol %, and the content of the nanosilica with respect to 100 parts by weight of the polyamide acid is 40 parts by weight. A charge concentration of the diamine component and the tetracarboxylic acid dianhydride component in this reaction solution was 18.5% by weight with respect to the entire reaction solution.

### <Preparation of Nanosilica-Containing Polyimide Film>

The obtained polyamide acid solution was cast on a square alkali-free glass plate (Eagle XG manufactured by Corning Incorporated) having sides of 150 mm and a thickness of 0.7 mm using a bar coater such that a thickness after drying was 10 μm, and was dried in a hot air oven at 80° C. for 30 minutes. Thereafter, the temperature was raised at a rate of 5° C./minute from 20° C. to 350° C. under a nitrogen atmosphere, heating was performed at 350° C. for 1 hour, and a laminate of a nanosilica-containing polyimide film (of which a polyimide has a thickness of 10 μm) and a glass plate was obtained. The nanosilica-containing polyimide film was peeled off from the glass plate, and physical properties of the nanosilica-containing polyimide film were evaluated. Evaluation results are shown in Table 2.

### Comparative Example 6

### <Synthesis of Nanosilica-Containing Polyamide Acid Solution>

24.0 g of organosilica sol: NMP-ST-R2 and 72.0 g of NMP were charged into a 500 mL glass separable flask equipped with a stirrer (having a stainless steel stirring bar) and a nitrogen inlet tube, and the mixture was stirred. Thereafter, 7.2 g of a 1% NMP solution of γ-APS was added and the mixture was stirred at 25° C. for 1 hour to perform a surface treatment of nanosilica. 11.8 g of 3,3′-dihydroxybenzidine (hereinafter may also be referred to as HAB) was added to this solution and was dissolved by stirring, and thereafter, 12.2 g of PMDA-HS was added and the mixture was stirred for 12 hours to obtain a nanosilica-containing polyamide acid solution (reaction solution). When the entire diamine component is 100 mol %, charge ratios of the monomers are as follows: PMDA-HS: 100 mol %, and HAB: 100 ml %, and the content of the nanosilica with respect to 100 parts by weight of the polyamide acid is 30 parts by weight. A charge concentration of the diamine compound and the tetracarboxylic acid dianhydride in this reaction solution was 19.0% by weight with respect to the entire reaction solution.

### <Preparation of Nanosilica-Containing Polyimide Film>

The obtained polyamide acid solution was cast on a square alkali-free glass plate (Eagle XG manufactured by Corning Incorporated) having sides of 150 mm and a thickness of 0.7 mm using a bar coater such that a thickness after drying was 10 μm, and was dried in a hot air oven at 80° C. for 30 minutes. Thereafter, the temperature was raised at a rate of 5° C./minute from 20° C. to 350° C. under a nitrogen atmosphere, heating was performed at 350° C. for 1 hour, and a laminate of a nanosilica-containing polyimide film (of which a polyimide has a thickness of 10 μm) and a glass plate was obtained. The nanosilica-containing polyimide film was peeled off from the glass plate, and physical properties of the nanosilica-containing polyimide film were evaluated. Evaluation results are shown in Table 2.

### INDUSTRIAL APPLICABILITY

The nanosilica-containing polyimide of an embodiment of the present invention is expected to be used as, for example, a TFT substrate material, an ITO substrate material, a printed matter, a color filter, a flexible display member, an anti-reflection film, a hologram, an optical member, or a building material and a structural object.

TABLE 2

| | Acid Dianhydride | | | | | | Nanosilica | | | |
|---|---|---|---|---|---|---|---|---|---|---|
| | (mol %) | | Diamine (mol %) | | | | content | Surface | Molecular | Film |
| | PMDA- | | 3,5- | | | | Parts by | treatment | weight | thickness |
| | HS | HBPDA | DABA | DABA | ODA | HAB | weight | agent | (Mw) | (μm) |
| Example 1 | 100 | | 100 | | | | 40 | γ-APS | 55,000 | 10 |
| Example 2 | 100 | | 50 | 50 | | | 40 | γ-APS | 30,000 | 10 |
| Example 3 | 100 | | 20 | 80 | | | 40 | γ-APS | 30,000 | 10 |
| Example 4 | 100 | | 20 | 80 | | | 30 | γ-APS | 30,000 | 10 |
| Example 5 | 65 | 35 | 20 | 80 | | | 40 | γ-APS | 35,000 | 10 |
| Example 6 | 65 | 35 | 30 | 70 | | | 30 | γ-APS | 35,000 | 10 |
| Comparative | 100 | | 100 | | | | 0 | γ-APS | 59,000 | 10 |
| Example 1 | | | | | | | | | | |
| Comparative | 100 | | 20 | 80 | | | 0 | γ-APS | 60,000 | 10 |
| Example 2 | | | | | | | | | | |
| Comparative | 100 | | | 100 | | | 0 | γ-APS | 45,000 | 10 |
| Example 3 | | | | | | | | | | |
| Comparative | 100 | | | 100 | | | 40 | γ-APS | 40,000 | 10 |
| Example 4 | | | | | | | | | | |
| Comparative | 100 | | | | 100 | | 40 | γ-APS | 60,000 | 10 |
| Example 5 | | | | | | | | | | |
| Comparative | 100 | | | | | 100 | 30 | γ-APS | 50,000 | 10 |
| Example 6 | | | | | | | | | | |

| | Transmittance | | | | Phase Difference | | |
|---|---|---|---|---|---|---|---|
| | | | | Total light | Expression | | CTE |
| | At 400 | Cut Off | Haze | transmittance | | (nx − ny)/ | CTE |
| | nm (%) | (nm) | (%) | (%) | nx − ny | 2 − nz | (ppm/K) |
| Example 1 | 80 | 298 | 0.2 | 90 | 0.0000 | 0.0005 | 29 |
| Example 2 | 82 | 313 | 0.3 | 90 | 0.0000 | 0.0030 | 32 |
| Example 3 | 80 | 331 | 0.2 | 90 | 0.0000 | 0.0070 | 35 |
| Example 4 | 80 | 331 | 0.2 | 90 | 0.0000 | 0.0080 | 39 |
| Example 5 | 80 | 331 | 0.2 | 90 | 0.0000 | 0.0080 | 39 |
| Example 6 | 80 | 331 | 0.2 | 90 | 0.0000 | 0.0080 | 39 |
| Comparative | 78 | 298 | 0.2 | 90 | 0.0001 | 0.0010 | 48 |
| Example 1 | | | | | | | |
| Comparative | 76 | 332 | 0.2 | 90 | 0.0001 | 0.0120 | 47 |
| Example 2 | | | | | | | |
| Comparative | 70 | 335 | 0.3 | 88 | 0.0000 | 0.0180 | 44 |
| Example 3 | | | | | | | |
| Comparative | 75 | 335 | 0.2 | 89 | 0.0000 | 0.0150 | 34 |
| Example 4 | | | | | | | |
| Comparative | 83 | 290 | 0.2 | 90 | 0.0000 | 0.0030 | 45 |
| Example 5 | | | | | | | |
| Comparative | 46 | 340 | 0.6 | 88 | 0.0000 | 0.0130 | 37 |
| Example 6 | | | | | | | |

1. A nanosilica-containing polyamide acid, comprising:
a polyamide acid that is a polymer of an alicyclic tetracarboxylic acid dianhydride and an aromatic diamine including a carboxyl group; and
nanosilica.

2. The nanosilica-containing polyamide acid of claim 1, wherein the alicyclic tetracarboxylic acid dianhydride has one of formulas (1)-(4)

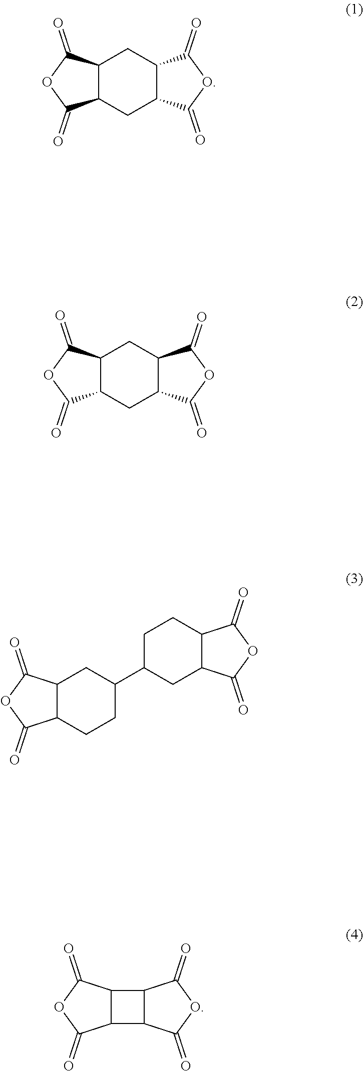 [SMILES: O=C1OC(=O)[C@@H]2C[C@H]3C(=O)OC(=O)[C@H]3C[C@H]12 ; O=C1OC(=O)[C@H]2C[C@H]3C(=O)OC(=O)[C@@H]3C[C@H]12 ; O=C1OC(=O)C2CC(C3CCC4C(=O)OC(=O)C4C3)CCC12 ; O=C1OC(=O)C2C1C1C(=O)OC(=O)C21]

3. The nanosilica-containing polyamide acid of claim 1, wherein the aromatic diamine comprises at least one diamine including one having formula (5) or (6)

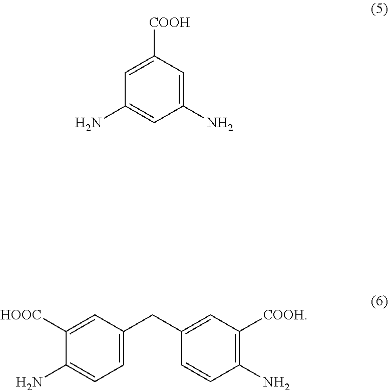 [SMILES: Nc1cc(N)cc(C(=O)O)c1 ; Nc1ccc(Cc2ccc(N)c(C(=O)O)c2)cc1C(=O)O]

4. The nanosilica-containing polyamide acid of claim 1, wherein the alicyclic tetracarboxylic acid dianhydride has formula (1), and
the aromatic diamine has formula (5)

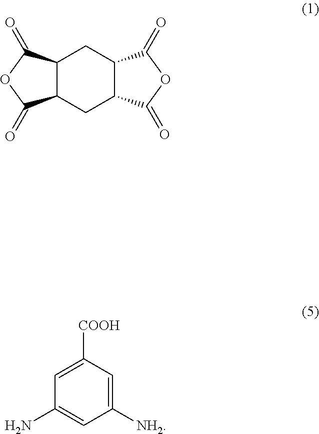 [SMILES: O=C1OC(=O)[C@@H]2C[C@H]3C(=O)OC(=O)[C@H]3C[C@H]12 ; Nc1cc(N)cc(C(=O)O)c1]

5. The nanosilica-containing polyamide acid of claim 1, wherein the nanosilica is included in an amount of from 5 parts by weight to 50 parts by weight with respect to 100 parts by weight of the polyamide acid.

6. A nanosilica-containing polyamide acid solution, comprising:
the nanosilica-containing polyamide acid of claim 1; and
an organic solvent.

7. A nanosilica-containing polyimide, comprising:
a polyimide that is an imidized product of an alicyclic tetracarboxylic acid dianhydride and an aromatic diamine including a carboxyl group; and
nanosilica.

8. The nanosilica-containing polyimide of claim 7, wherein the alicyclic tetracarboxylic acid dianhydride has one of formulas (1)-(4)

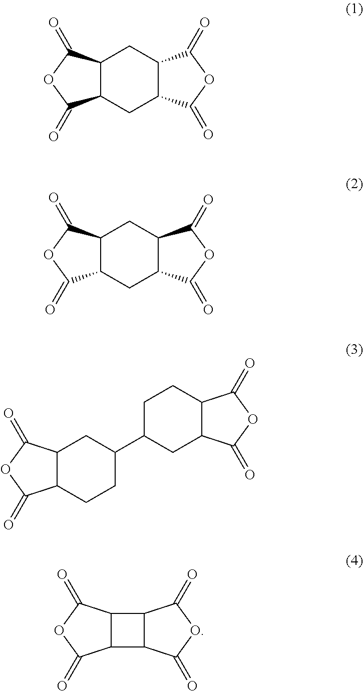 [SMILES: O=C1OC(=O)[C@@H]2C[C@H]3C(=O)OC(=O)[C@H]3C[C@H]12 ; O=C1OC(=O)[C@H]2C[C@H]3C(=O)OC(=O)[C@@H]3C[C@H]12 ; O=C1OC(=O)C2CC(C3CCC4C(=O)OC(=O)C4C3)CCC12 ; O=C1OC(=O)C2C1C1C(=O)OC(=O)C21]

9. The nanosilica-containing polyimide of claim 7, wherein the aromatic diamine comprises at least one diamine including one having formula (5) or (6).

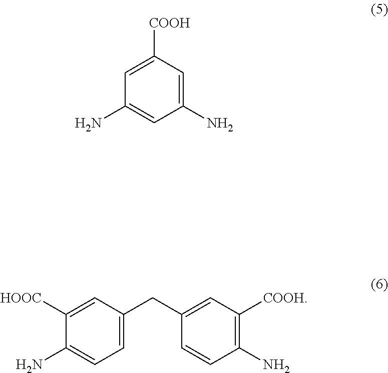 [SMILES: Nc1cc(N)cc(C(=O)O)c1 ; Nc1ccc(Cc2ccc(N)c(C(=O)O)c2)cc1C(=O)O]

10. The nanosilica-containing polyimide of claim 7, wherein the alicyclic tetracarboxylic acid dianhydride has formula (1), and
the aromatic diamine has formula (5)

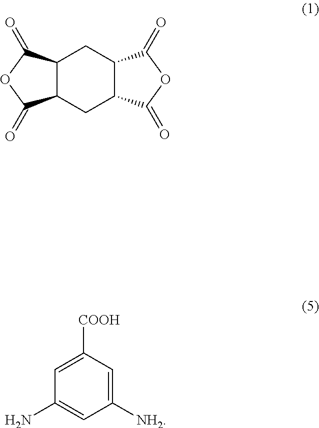 [SMILES: O=C1OC(=O)[C@@H]2C[C@H]3C(=O)OC(=O)[C@H]3C[C@H]12 ; Nc1cc(N)cc(C(=O)O)c1]

11. The nanosilica-containing polyimide of claim 7, wherein the nanosilica is included in an amount of from 5 parts by weight to 50 parts by weight with respect to 100 parts by weight of the polyimide.

12. The nanosilica-containing polyimide of claim 7, wherein the nanosilica-containing polyimide in a form of a 10 μm-thick film has a light transmittance at a wavelength of 400 nm of 60% or more.

13. The nanosilica-containing polyimide of claim 7, wherein the nanosilica-containing polyimide in a form of a 10 μm-thick film has a cutoff wavelength of from 310 nm to 390 nm.

14. The nanosilica-containing polyimide of claim 7, wherein the nanosilica-containing polyimide in a form of a 10 μm-thick film has a linear thermal expansion coefficient at 100-250° C. of 50 ppm/K or less.

15. The nanosilica-containing polyimide of claim 7, wherein the nanosilica-containing polyimide satisfies
nx−ny<0.0010 and
(nx+ny)/2−nz<0.0150,
where nx is a maximum in-plane refractive index, ny is a minimum in-plane refractive index, and nz is a thickness direction refractive index.

16. A nanosilica-containing polyimide laminate, comprising:
a substrate; and
the nanosilica-containing polyimide of claim 7.

17. A method of producing a nanosilica-containing polyimide laminate, comprising:
casting the nanosilica-containing polyamide acid of claim 1 onto a substrate; and
thermally imidizing the nanosilica-containing polyamide acid.

18. A method of producing a nanosilica-containing polyimide, comprising:
casting the nanosilica-containing polyamide acid solution of claim 6 onto a substrate;
thermally imidizing the nanosilica-containing polyamide acid solution; and
peeling off a nanosilica-containing polyimide obtained after thermal imidization.

19. A method of producing a flexible device substrate, comprising
forming an electronic element on a polyimide obtained from the nanosilica-containing polyamide acid of claim 1.

20. A method of a flexible device substrate, comprising:
casting the nanosilica-containing polyamide acid of claim 1 onto a substrate;
thermally imidizing the nanosilica-containing polyamide acid; and
forming an electronic element on a thermally imidized polyimide.

21. A method of producing a flexible device substrate, comprising:
casting the nanosilica-containing polyamide acid of claim 1 onto a substrate;
thermally imidizing the nanosilica-containing polyamide acid;
forming an electronic element on a thermally imidized polyimide; and
peeling off the electronic element and the polyimide from the substrate.

22. A flexible device substrate, comprising:
the nanosilica-containing polyimide of claim 7; and
an electronic element.
